(19) United States
(12) Patent Application Publication
(10) Pub. No.: US 2025/0233955 A1
(43) Pub. Date: Jul. 17, 2025

(54) IMAGE FORMING APPARATUS, IMAGE FORMING METHOD, AND STORAGE MEDIUM

(71) Applicant: Konica Minolta, Inc., Tokyo (JP)

(72) Inventors: Masahiro KAMIYA, Toyohashi-shi (JP); Takeshi NOMURA, Toyohashi-shi (JP); Yasuhiro ISHIHARA, Toyohashi-shi (JP); Yoshikazu WATANABE, Toyohashi-shi (JP); Takaki UEMURA, Seto-shi (JP)

(21) Appl. No.: 19/012,123

(22) Filed: Jan. 7, 2025

(30) Foreign Application Priority Data
Jan. 12, 2024 (JP) 2024-002915

(51) Int. Cl. H04N 1/23

(52) U.S. Cl. CPC H04N 1/2323; H04N 1/2338; H04N 1/2369; H04N 1/2392

(57) ABSTRACT

An image forming apparatus includes a hardware processor; a supplier that supplies a sheet; an image former; and a sensor that senses an operation of opening and/or closing a paper cassette containing the sheet. An image is formed in any mode between an automatic sensing mode in which the sheet type is discriminated by the hardware processor, and a type specifying mode in which the sheet type is accepted by the hardware processor. In a case in which it is judged that the mode is switched, the hardware processor automatically switches the mode when the image former forms the image. In a case in which the type specifying mode is set, the hardware processor judges, based on sensing of at least one of the operation of opening and/or the operation of closing by the sensor, whether to switch the mode to the automatic sensing mode.

### CROSS REFERENCE TO RELATED APPLICATIONS

The present invention claims priority under 35 U.S.C. § 119 to Japanese Application No. 2024-002915 filed Jan. 12, 2024, the entire content of which is incorporated herein by reference.

### BACKGROUND OF THE INVENTION

### Technical Field

The present invention relates to an image forming apparatus, an image forming method, and a storage medium.

### Description of Related Art

Conventionally, there has been known an image forming apparatus provided with a sheet type discriminator (“paper type sensor” in Japanese Unexamined Patent Publication No. 2007-062963) for detecting a type of a sheet (paper). When printing is performed on a sheet of a different type, a scheduled finish is not always obtained.

For this reason, for example, Japanese Unexamined Patent Publication No. 2007-062963 describes that printing is stopped when information of a sheet type detected by a sheet type discriminator is different from information of a sheet type specified from the outside.

Even in a case in which the sheet type discriminator is provided, automatic setting for judging the type of the sheet used for printing based on an automatic discrimination result by the sheet type discriminating means and manual setting for judging the type of the sheet based on manual setting by a user are possible.

However, there are users who cannot correctly discriminate and set the type of sheet to be used. Furthermore, some users do not recognize that automatic setting/manual setting exists in a selectable manner.

For such a user, when the image forming apparatus is in a state in which the type of sheet is manually set, in a case where a plurality of types of sheets are used, it is necessary to manually change the setting of the sheet type each time, which is troublesome and time-consuming. In addition, in a case of a user who has no knowledge about the type of sheet, it is assumed that there may be cases in which the type of sheet cannot be correctly set and a normal print result cannot be obtained.

On the other hand, some users may want to use the image forming apparatus with manual setting. In this case, if the setting is changed to the automatic setting each time, the user feels burdensome to return the setting to the manual setting each time the user uses the image forming apparatus. Further, there is a case where the sheet type to be used is fixed, or there is a user who uses the sheet which is difficult to be automatically discriminated.

In addition, if the state is in automatic setting in a case where a sheet unsuitable for automatic detection is set, the sheet type is used in a state in which the sheet type may be erroneously sensed. As a result, there are concerns about a decrease in productivity and the occurrence of jam.

Further, in the judgment of the type of the sheet, in a case where the image forming apparatus is provided with the automatic setting and the manual setting, when the setting is uniformly switched from the manual setting to the automatic setting, a case where the setting contradicts the intention of the user is also assumed. Therefore, it is desired that the judgement of the sheet type be set in a manner most convenient for the user in accordance with various situations.

### SUMMARY OF THE INVENTION

The present invention has been made in view of the above points, and an object of the present invention is to provide an image forming apparatus, an image forming method, and a storage medium capable of changing a setting related to judgement of a sheet type depending on a use situation of the image forming apparatus.

To achieve at least one of the abovementioned objects, according to an aspect of the present invention, an image forming apparatus reflecting one aspect of the present invention includes, a hardware processor; a supplier that supplies a sheet; an image former; and a sensor that senses at least one of an operation of opening and/or closing a paper cassette containing the sheet by a user operation, wherein, the hardware processor discriminates a sheet type supplied by the supplier, the hardware processor accepts specifying of the sheet type by a user, an image is formed in any mode between an automatic sensing mode in which the image former forms the image on the supplied sheet by the sheet type discriminated by the hardware processor, and a type specifying mode in which the image former forms the image on the supplied sheet based on the sheet type accepted by the hardware processor, the hardware processor judges and sets in which mode the image is formed by the image former, the hardware processor judges whether to switch the set mode, in a case in which it is judged that the mode is switched, the hardware processor automatically switches the mode when the image former forms the image, and in a case in which the type specifying mode is set, the hardware processor judges, based on sensing of at least one of the operation of opening and/or the operation of closing by the sensor, whether or not to switch the mode from the type specifying mode to the automatic sensing mode.

According to an aspect of the present invention, an image forming method reflecting one aspect of the present invention includes, discriminating a sheet type of a sheet supplied by a supplier; accepting specification of the sheet type by a user; forming an image in any mode between an automatic sensing mode in which an image is formed on the supplied sheet in accordance with the discriminated sheet type, and a type specifying mode in which the image is formed on the supplied sheet in accordance with the accepted sheet type, judging and setting in which mode the image is formed in the image forming; judging whether to switch the mode set in the mode setting; in a case in which it is judged in the determining of switching that the mode is to be switched, automatically switching the mode when the image is formed in the image forming; and sensing at least one of an operation of opening and/or an operation of closing a paper cassette containing the sheet by a user operation, wherein in a case in which the type specifying mode is set in the mode setting, it is judged in the judging of switching, whether to switch the mode from the type specifying mode to the automatic sensing mode, based on sensing of at least one of the operation of opening and/or the operation of closing.

According to an aspect of the present invention, a storage medium reflecting one aspect of the present invention storing a program causing a computer to perform: discriminating a sheet type of a sheet supplied by a supplier; accepting specification of the sheet type by a user; forming an image in any mode between an automatic sensing mode in which an image is formed on the supplied sheet in accordance with the discriminated sheet type, and a type specifying mode in which the image is formed on the supplied sheet in accordance with the accepted sheet type, judging and setting in which mode the image is formed in the image forming; judging whether to switch the mode set in the mode setting; in a case in which it is judged in the determining of switching that the mode is to be switched, automatically switching the mode when the image is formed in the image forming; and sensing at least one of an operation of opening and/or an operation of closing a paper cassette containing the sheet by a user operation, wherein in a case in which the type specifying mode is set in the mode setting, it is judged in the judging of switching, whether to switch the mode from the type specifying mode to the automatic sensing mode, based on sensing of at least one of the operation of opening and/or the operation of closing.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating a schematic configuration of the inside of an image forming apparatus according to the present embodiment,

FIG. 2 is a main part block diagram illustrating a schematic control configuration of the image forming apparatus according to the present embodiment,

FIG. 3 is an explanatory view schematically showing a state in which the paper cassette is opened and closed by a user operation,

FIG. 4 is a schematic explanatory diagram illustrating a positional relationship of a medium sensing sensor,

FIG. 5 is a schematic explanatory diagram illustrating a configuration of the medium sensing sensor,

FIG. 6 is a flowchart illustrating a flow of mode switching judgement when setting a sheet type in an image forming system according to the first embodiment,

FIG. 7A is an example of a setting screen for setting a sheet size and a sheet type,

FIG. 7B is an example of a setting screen for setting a sheet size and a sheet type,

FIG. 8 is a diagram illustrating an example of a list of sheet types stored in the storage section,

FIG. 9A is a display screen example in a case where a message is displayed on a display panel regarding switching of the mode,

FIG. 9B is the display screen example in a case where the message is displayed on the display panel regarding switching of the mode,

FIG. 9C is the display screen example in a case where the message is displayed on the display panel regarding switching of the mode,

FIG. 10 is a flowchart for explaining the flow of mode switching judgement when setting the sheet type in the image forming system according to the second embodiment,

FIG. 11 is an explanatory diagram schematically showing a processing example related to mode switching according to the second embodiment,

FIG. 12 is an explanatory diagram schematically showing the processing example related to mode switching according to the second embodiment; and

FIG. 13 is a screen example illustrating an example of an administrator setting screen.

### DETAILED DESCRIPTION

Hereinafter, one or more embodiments of the present invention will be described with reference to the drawings. However, the scope of the invention is not limited to the disclosed embodiments.

Hereinafter, an embodiment of an image forming apparatus, an image forming method, and a storage means according to the present invention will be described with reference to the drawings. It should be noted that the following embodiments are provided with various limitations that are technically preferable for carrying out the present invention, but the scope of the present invention is not limited to the following embodiments and illustrated examples.

### First Embodiment

### Configuration of Image Forming Apparatus 100

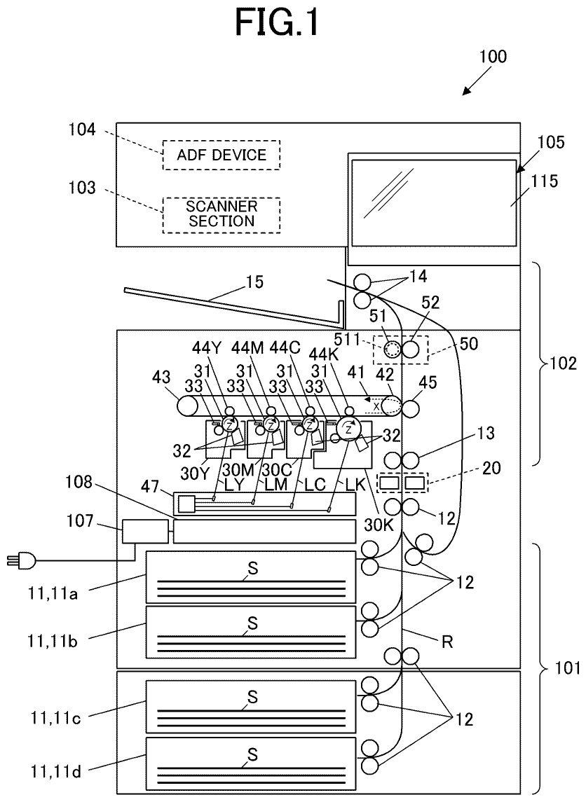

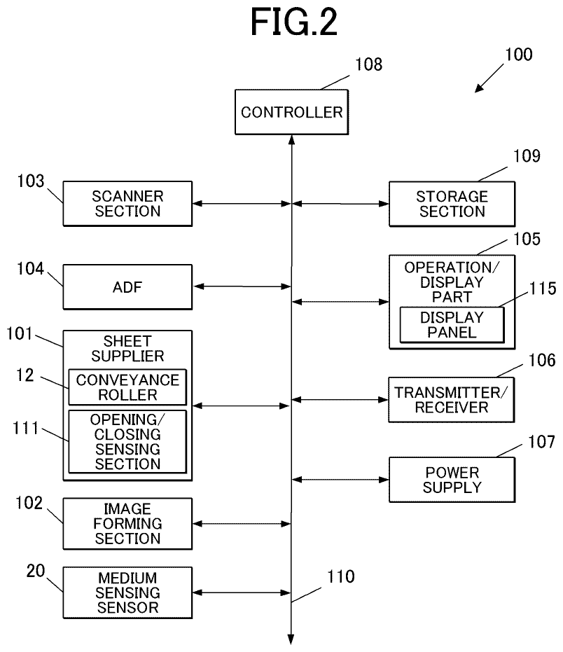

FIG. 1 is a diagram illustrating a schematic configuration of the inside of an image forming apparatus according to an embodiment of the present invention. FIG. 2 is a block diagram illustrating a main functional configuration of the image forming apparatus.

As illustrated in FIG. 1, the image forming apparatus 100 includes a sheet supplier (supplier) 101, an image forming section (image former) 102, a scanner section 103, a ADF 104, an operation/display part 105, a power supply 107, and the like. In addition, as illustrated in FIG. 2, the image forming apparatus 100 includes a transmitter/receiver 106, a controller 108 (hardware processor), a storage section 109, and the like. These components are connected to each other by a bus 110.

The image forming apparatus 100 prints (forms) a full-color or monochrome image on a sheet S by an electrophotographic method, based on image data. The image data is image data of a document input from an external terminal device or the like via the transmitter/receiver 106 (see FIG. 2) connected to a network (e.g., a LAN), or image data input by reading a document with the scanner section 103.

In the embodiment, the sheet S is various types of recording media. In the following description, even when the term “paper” is used as a term indicating the sheet S, the term is not limited to so-called “paper”, and broadly includes various sheet-shaped recording media used as a printing target, such as an OHP sheet, in addition to various types of recording paper such as plain paper.

A scanner section 103 and an automatic document feeder (ADF) 104 are provided in an upper portion of the image forming apparatus 100.

The ADF 104 automatically feeds a document to a document plate.

The scanner section 103 includes a scanner (not shown) below a contact glass (document plate) on which the document is placed and reads an image of the document. The scanner includes a light source, a charge coupled device (CCD), an imaging optical system, an A/D converter, and the like. Illumination light from a light source scans the document, and the reflected light from the document surface forms an image on the CCD. The image of the document is photoelectrically converted by the CCD and read as R, G, and B signals. The read image is converted from an analog signal into a digital signal by an A/D converter and is output to an image processor. Here, the image is not limited to image data such as a figure or a photograph and includes image data obtained by converting text data such as characters or symbols into image data.

Further, the operation/display part 105 is provided at an upper portion of the image forming apparatus 100. The operation/display part 105 is a display means including a display panel 115 such as a liquid crystal display (LCD). On the display panel 115, a screen for notifying the user of various apparatus states and messages is appropriately displayed. Furthermore, the display panel 115 is integrally formed with a touch screen on which a user can perform a touch operation.

The user of the image forming apparatus 100 can specify the type of the sheet S to be used for printing, the type of printing, and the like by operating the operation/display part 105 (touch screen of the operation/display part 105). The type of the sheet S is, for example, whether the sheet S is plain paper or various types of special paper, specifying of a size, or the like. The type of printing is, for example, color printing or monochrome printing, or double-sided printing or single-sided printing. Content input by the user through the operation/display part 105 (touch screen of the operation/display part 105) is accepted by the controller 108.

Furthermore, as described later, the image forming apparatus 100 according to the present embodiment includes an automatic sensing mode in which an image is formed with the type of sheet discriminated by the sheet type discrimination function and a type specifying mode in which the image is formed with the type of sheet accepted by the sheet type specification acceptance function. Then, the image forming section 102 of the image forming apparatus 100 can perform image formation in any of these modes. The user can set in which mode the image formation is performed by operating the operation/display part 105 (touch screen of the operation/display part 105).

Further, on the display panel 115 of the operation/display part 105, various guidance screens, inquiry screens, setting screens, and the like are appropriately displayed based on the control of the controller 108. Note that a specific display screen example will be described later.

Further, as shown in FIG. 1, the image forming apparatus 100 of the embodiment includes a sheet supplier 101 at a lower position of the apparatus. In the image forming apparatus 100, the image forming section 102 for forming the image on the sheet S fed by the sheet supplier 101 is provided above the sheet supplier 101.

The sheet supplier 101 includes a plurality of paper cassettes 11, a plurality of conveyance means for feeding sheets S from the paper feed cassettes 11 into a conveyance path R, and the like. The conveyance means is, for example, conveyance rollers 12 (see FIG. 1).

Each of the paper cassettes 11 stores various sheets S. The operation of the conveyance roller 12 is controlled by the controller 108 (to be described later), and the conveyance roller 12 feeds the sheet S to be used for printing to the conveyance path R one by one.

FIG. 1 illustrates a case where four paper cassettes 11a, 11b, 11c, and 11d are prepared as the paper cassettes 11. The configurations of the paper cassettes 11a, 11b, 11c, and 11d are substantially the same, and when simply referred to as “paper cassette 11”, all of these are included.

The number of the paper cassettes 11 is not limited to four and may be more or less than four. The paper cassettes 11 may store sheets S of the same type or sheets S of different paper types.

When the sheets S accommodated in the paper cassette 11 are used up and the paper cassette 11 becomes empty, the printing operation is temporarily stopped, and a standby state (stop state) is set until the sheets S are refilled. In this case, the user opens and closes the paper cassette 11 to refill the paper cassette 11 with the sheets S.

Each paper cassette 11 is provided with an opening/closing sensing section 111 that senses at least one of an operation of opening (opening operation) and/or an operation of closing (closing operation) the paper cassette 11 by the user operation.

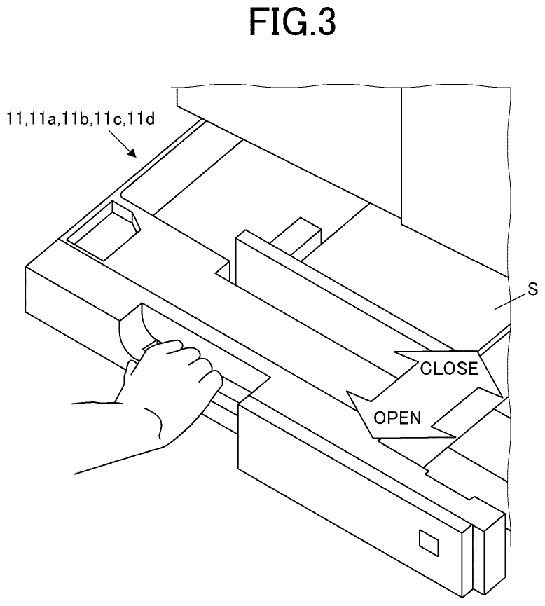

FIG. 3 is an explanatory view schematically showing a state in which the paper cassette is opened and closed by a user operation.

As shown in FIG. 3, the paper cassette 11 of the present embodiment is brought into an open state by being pulled out to the apparatus front side (front surface side) and is brought into a closed state by being pushed in toward the apparatus inner side. Since the paper cassettes 11a, 11b, 11c, and 11d have substantially the same configuration, they are illustrated without being distinguished in FIG. 3.

The opening/closing sensing section 111 only needs to be capable of sensing the opening/closing operation as illustrated in FIG. 3, and a specific position, a configuration, and the like where the opening/closing sensing section 111 is provided are not particularly limited. The opening/closing sensing section 111 may be, for example, a sensor that senses light entering the paper cassette 11 when the paper cassette 11 is opened or closed. Furthermore, the opening/closing sensing section 111 may be any of various optical sensors such as a sensor which includes a light emitting portion and a light receiving portion and which detects that light from the light emitting portion is blocked when the paper cassette 11 is opened or closed. Further, the opening/closing sensing section 111 may be, for example, various switches or the like having a mechanical configuration that detects opening and closing by a convex portion or the like being pushed in or released when the paper cassette 11 is opened and closed. A sensing result by the opening/closing sensing section 111 is output to the controller 108 which will be described later and is acquired by the controller 108.

The sheet S sent out from the paper cassette 11 onto the conveyance path R is sent to the image forming section 102 by the conveyance roller 12.

A registration roller 13 is provided on the conveyance path R at a position to the front than the image forming section 102. The sheet S conveyed on the conveyance path R once abuts against the registration roller 13 and is sent to the image forming section 102 at an appropriate timing.

A medium sensing sensor 20 is provided on an immediate downstream side of the merging position of the paper cassettes 11 and before (upstream side) the registration roller 13. By providing the medium sensing sensor 20 at this position, the sheet S always passes through a sensing position of the medium sensing sensor 20 before being sent to the image forming section 102 even when the sheet S is sent from any of the paper cassettes 11.

The medium sensing sensor 20 is a measuring section that irradiates the sheet S with light and measures physical properties of the sheet S by transmittance and reflectance of the irradiated light.

As described above, the image forming apparatus 100 includes, as modes for performing image formation, the automatic sensing mode in which the sheet type is automatically sensed and the type specifying mode in which the sheet type is manually specified by the user. In the automatic sensing mode, the medium sensing sensor 20 senses various values serving as judging materials when the controller 108 discriminates (estimates) the type of the sheet S.

For example, the medium sensing sensor 20 outputs a signal indicating a basis weight of the sheet S. The medium sensing sensor 20 may output the signal indicating a characteristic value other than the basis weight of the sheet S. The controller 108, which will be described later, refers to the output signal of the medium sensing sensor 20 and automatically discriminates (estimates) the type of the sheet S based on the sensing result (measurement result) by the medium sensing sensor 20.

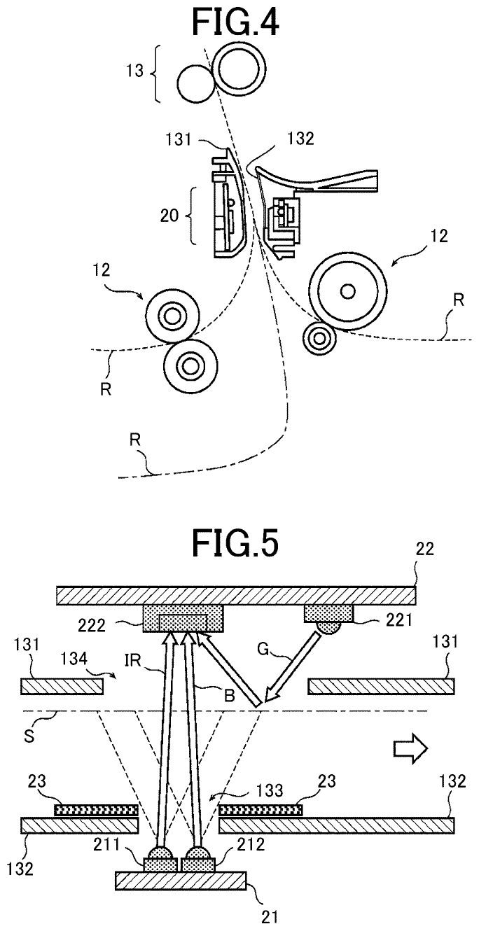

Here, a configuration of the medium sensing sensor 20 will be described with reference to FIG. 4 and FIG. 5.

As illustrated in FIG. 4, conveyance guide plates 131 and 132 that guide the sheet S to the registration rollers 13 are provided on the conveyance path R in the present embodiment, and the medium sensing sensor 20 is attached to the conveyance guide plates 131 and 132. Note that the medium sensing sensor 20 may be fixed to another member.

As illustrated in FIG. 5, the medium sensing sensor 20 includes a light emitting substrate 21 and a light receiving/emitting substrate 22. A light emitting diode (LED) 211 that emits near-infrared light IR and an LED 212 that emits blue light B are mounted on the light emitting substrate 21. The emitted lights IR and B of the LED 211 and LED 212 are applied to the sheet S via a through hole 133 provided in the conveyance guide plate 132. Some of the light applied to the sheet S is transmitted and travels toward the light receiving/emitting substrate 22.

In addition, a LED 221 that emits green light G and a photodiode 222 that outputs a detection signal corresponding to the amount of incident light are mounted on the light receiving/emitting substrate 22. Emission light G of the LED 221 is emitted to the sheet S via a through hole 134 provided in the conveyance guide plate 131. Some of the light applied to the sheet S is reflected and travels toward the photodiode 222.

When the sheet S is not present on the optical path along which the near-infrared light IR and the blue light B travel from the LED 211 and LED 212 to the photodiode 222, the near-infrared light IR and the blue light B are directly incident on the photodiode 222 without being blocked by the sheet S. With reference to this amount of incident light, the transmittance of the near-infrared light IR and the blue light B is evaluated for each recording sheet.

On a surface of the conveyance guide plate 132 facing the light receiving/emitting substrate 22, a reflection light source reference substrate 23 is disposed at a position where the emission light G of the LED 221 enters. When the sheet S is not present on the optical path along which the green light G travels from the LED 221 to the reflection light source reference substrate 23 and on the optical path along which the green light G travels from the reflection light source reference substrate 23 to the photodiode 222, the green light Gis reflected by the reflection light source reference substrate 23 and enters the photodiode 222 without being blocked by the sheet S. With reference to the amount of incident light, the reflectance of the green light G is evaluated for each sheet S.

The transmittance and reflectance of the near-infrared light IR, the blue light B, and the green light G may vary depending on the basis weight of the sheet S. Therefore, the basis weight of the sheet S can be discriminated by calculating the transmittance of the near infrared light IR and the blue light B or calculating the reflectance of the green light G with reference to the detection signal of the photodiode 222.

The sheet S sent out onto the conveyance path R is sent to the image forming section 102 after passing through the detection position of the medium sensing sensor 20.

The image forming section 102 forms the toner image with toner in each color of yellow (Y), magenta (M), cyan (C), and black (K), and transfers and fixes the toner image onto the sheet S supplied from the sheet supplier 101.

The image forming section 102 includes an intermediate transfer belt 41 disposed along a horizontal direction at a substantially central portion in a vertical direction of the apparatus. The intermediate transfer belt 41 is wound around a pair of belt circulation rollers 42 and 43 and circulates in a direction indicated by arrow X by a motor (not illustrated).

Below the intermediate transfer belt 41, process units 30 (process units 30Y, 30M, 30C, and 30K), each of which is detachable from an apparatus main body, are provided. The process units 30 are disposed in this order along a direction of rotation movement of the intermediate transfer belt 41. Each of the process units 30 includes a plurality of process units that form toner images with toners of yellow (Y), magenta (M), cyan (C), and black (K). Each of the process units 30 is detachable from the apparatus main body by being pulled toward the front side (the side closer to the viewer of the page of FIG. 1) with respect to the apparatus main body. Furthermore, each of the process units 30 is attached to the apparatus main body by being inserted into the apparatus main body toward an inner side. Note that the toners are not limited to the four colors shown here. When a toner of another color is provided, a process unit for forming the toner image with the toner is further provided.

Above the intermediate transfer belt 41, toner accommodation sections (not illustrated) are provided above the process units 30Y, 30M, 30C, and 30K, respectively, with the intermediate transfer belt 41 interposed therebetween. The toner accommodation sections store toners of the respective colors of yellow (Y), magenta (M), cyan (C), and black (K). The toners contained in the respective toner accommodation sections corresponding to the respective colors of yellow (Y), magenta (M), cyan (C), and black (K) are supplied to the respective process units 30 by a toner supply mechanism (not shown).

The process units 30Y, 30M, 30C, and 30K include the respective photosensitive drums 31 that are rotatably disposed below the intermediate transfer belt 41 so as to face the intermediate transfer belt 41. A photosensitive layer is provided over the entire circumference of the surface of each photosensitive drum 31, and each photosensitive drum 31 is rotated in the direction indicated by the arrow Z. Charging devices 32 that uniformly charge the photosensitive layers of the photosensitive drums 31 to a predetermined charging potential are provided in this order along the rotation direction on the downstream side in the rotation direction of the photosensitive drums 31 with respect to the upper portions of the photosensitive drums 31 facing the intermediate transfer belt 41.

The photosensitive drum 31 charged by the charging device 32 is irradiated with laser beams LY, LM, LC, and LK from an exposure device 47 on the downstream side of the charging device 32 in the rotation direction of the photosensitive drum 31. The exposure device 47 is provided with four semiconductor laser elements. Laser beams LY, LM, LC, and LK emitted from the respective semiconductor laser elements of the exposure device 47 based on image data are applied to the photosensitive layers of the respective photosensitive drums 31 via a polygon mirror, a scanning lens, and the like. Thus, an electrostatic latent image is formed on the photosensitive layer of each photosensitive drum 31 uniformly charged by each charging device 32.

In each of the process units 30, a developing device 33 is provided on the downstream side in the rotation direction with respect to an exposure position of each of the photosensitive drums 31 by the laser beams LY, LM, LC, and LK. The respective developing devices 33 develop the electrostatic latent images formed on the photosensitive layers of the respective photosensitive drums 31 with toners using two component developers including toners of the respective colors of Y, M, C, and K and carriers having magnetism.

Each of the photosensitive drum 31, the charging device 32, and the developing device 33 in each process unit 30 constitutes process means for forming the toner image. The configuration of the process means provided in each of the process units 30Y, 30M, 30C and 30K is the same in each of the process units 30. Therefore, in FIG. 1, they are not distinguished by adding Y, M, C, and K. In addition, FIG. 1 is merely a schematic view, and does not accurately show the arrangement, shape, and the like of each component.

Above the process units 30, primary transfer rollers 44Y, 44M, 44C, and 44K are provided so as to face the respective photosensitive drums 31 with the intermediate transfer belt 41 in between. Each of the primary transfer rollers 44Y, 44M, 44C, and 44K is attached to the apparatus main body. When the transfer bias voltage is applied to each of the primary transfer rollers 44Y, 44M, 44C, and 44K, an electric field is formed between each of the primary transfer rollers and each of the photosensitive drums 31 facing each of the primary transfer rollers.

The toner images formed on the respective photosensitive drums 31K are primarily transferred onto the intermediate transfer belt 41 by action of electric fields respectively formed between the primary transfer rollers 44Y, 44M, 44C, 44K and the respective photosensitive drums 31.

Note that in a case of forming a full-color image, timings of the image forming operations of the process units 30Y, 30M, 30C, and 30K are shifted from one another so that the toner images formed on the respective photosensitive drums 31 are superimposed and transferred onto the same region on the intermediate transfer belt 41.

On the other hand, when a monochrome image is formed, a toner image is formed on the photosensitive drum 31 of only one selected process unit (for example, the process unit 30K for the K toner), and the formed toner image is transferred onto a predetermined region of the intermediate transfer belt 41 by the primary transfer roller 44K disposed to face the process unit.

Although not shown, each of the process units 30 is provided with a cleaning section. The toner remaining on the surface of each photosensitive drum 31 onto which the toner image has been transferred is scraped off by the cleaning section.

The intermediate transfer belt 41 transports the transferred toner image to an end portion (end portion on the right side in FIG. 1) around which one belt circulation roller 42 is wound by the circulation movement. A secondary transfer roller 45 is disposed opposite the belt circulation roller 42 with the intermediate transfer belt 41 therebetween. The secondary transfer roller 45 is pressed against the intermediate transfer belt 41 to form a transfer nip therebetween. A transfer bias voltage is applied to the secondary transfer roller 45. Application of the transfer bias voltage forms an electric field between the secondary transfer roller 45 and the intermediate transfer belt 41.

To the transfer nip formed by the secondary transfer roller 45 and the intermediate transfer belt 41, the sheet S fed from the paper cassette 11 of the sheet supplier 101 to the conveyance path R is conveyed. The toner image transferred onto the intermediate transfer belt 41 is secondarily transferred onto the sheet S conveyed through the conveyance path R by the action of an electric field formed between the secondary transfer roller 45 and the intermediate transfer belt 41.

The sheet S that has passed through the transfer nip is conveyed to a fixing device 50 disposed above the secondary transfer roller 45. The fixing device 50 includes a heating roller 51 and a pressure roller 52 which are pressed against each other. The heating roller 51 and the pressure roller 52 are pressed against each other, thereby forming a fixing nip therebetween. A heating means 511 is disposed at an axial center part of the heating roller 51. The heating means 511 is, for example, a heater lamp. The heating roller 51 is heated by the heating means 511.

In the fixing device 50, the unfixed toner image on the sheet S is fixed by being heated and pressurized while passing through the fixing nip formed by the heating roller 51 and the pressure roller 52. The sheet S on which the toner image has been fixed is ejected by sheet ejection rollers 14 onto a sheet ejection tray 15 disposed above the process units 30 and the like.

Note that although the embodiment in which the image forming section 102 of the image forming apparatus 100 forms an image by an electrophotographic method has been described here, the image forming section of the image forming apparatus may use another method such as an inkjet method.

In addition, the controller 108 of the image forming apparatus 100 is, for example, a central processing unit (CPU), a read only memory (ROM) which is a non-volatile memory, or a volatile memory (not illustrated) such as a RAM (Random Access Memory) and the like.

These are connected to one another by an internal bus (none of which is illustrated) for communication. The CPU of the controller 108 reads various processing programs stored in the ROM or the like and develops the programs in the RAM. Then, the CPU comprehensively controls operation of sections of the image forming apparatus 100 in cooperation with the various programs developed in the RAM.

For example, when the image forming apparatus 100 is powered on and a reset signal is input to the CPU, the CPU reads the boot program from the ROM and starts the boot program. Next, the CPU uses the RAM as a working storage area to execute an operating system (OS) and a control program that are read from an HDD (Hard Disk Drive), which is an auxiliary storage device. Instead of the HDD, a solid state drive (SSD) may be used as the auxiliary storage device.

The storage section 109 includes a dynamic random access memory (DRAM), a hard disk drive (HDD), and the like, and stores image data input by the scanner section 103, image data input from the outside via the transmitter/receiver 106, and the like. Note that these image data and the like may be stored in the RAM or the like of the controller 108.

Further, the storage section 109 in the embodiment stores determination information for determining the type of the sheet S. The determination information is information indicating the type of the sheet S estimated from the output signal of the medium sensing sensor 20. For example, the medium sensing sensor 20 outputs a signal indicating the basis weight of the sheet S. In this case, the determination information is a table or the like in which a signal indicating the basis weight and the type of the sheet S corresponding thereto are defined. The determination information is not particularly limited as long as the controller 108 can estimate the type of the sheet S based on the output signal (output information) from the medium sensing sensor 20.

As described above, in the present embodiment, as modes for setting a sheet type when the image forming section 102 performs image formation, the automatic sensing mode and the type specifying mode are included. The controller 108 also functions as a mode setting means for judging and setting in which mode the image forming section 102 performs image formation.

For example, at the time of factory shipment or the like, the automatic sensing mode is set as a default.

In the automatic sensing mode, the controller 108 functions as a sheet type discriminator for discriminating (estimating) the type of the sheet S supplied by the sheet supplier 101 with reference to the output signal of the medium sensing sensor 20.

In addition, in the present embodiment, the controller 108 functions as a sheet type specification acceptance means for accepting the specification of the type of the sheet S by the user. That is, the user can set the type specifying mode by an input operation or the like to the operation/display part 105. In this case, the type of the sheet S specified by the user through the operation on the operation/display part 105 or the like is accepted by the controller 108.

When the type of the sheet S to be used for image formation is finalized either automatically (automatic sensing mode) or manually specified by the user (type specifying mode), the controller 108 sets process conditions so that image formation corresponding to the finalized type of the sheet S is performed.

Process conditions for forming a high-quality image vary depending on the type of the sheet S. Therefore, in order to form the high-quality image on various sheets S, it is necessary to set suitable process conditions according to the characteristics of each sheet S. Here, the process conditions include, for example, a secondary transfer voltage, a fixing temperature, and a sheet conveyance speed.

The type of the sheet S and process conditions corresponding to the sheet type are stored in, for example, the storage section 109 or the like, and when the sheet S to be used for image formation is finalized, the controller 108 acquires the corresponding process conditions from the storage section 109 and appropriately controls the operation of each section of the image forming section 102, the conveyance roller 12, or the like.

The controller 108 also functions as a switching judgement means for judging whether to switch the mode (the automatic sensing mode or the type specifying mode) set as the mode setting means.

Then, the controller 108 also functions as a switching means for automatically switching the mode when the image forming section 102 forms the image in a case where it is judged that the set mode is switched to the other mode.

In the present embodiment, as described above, when the opening/closing sensing section 111 senses at least one of an operation of opening (opening operation) and/or an operation of closing (closing operation) the paper cassettes 11 that stores sheets S performed by the user operation, a sensing signal is output to the controller 108. Thus, the controller 108 senses that the paper cassette 11 has been opened or closed.

Next, upon sensing that the paper cassette 11 has been opened or closed, the controller 108 as switching judgement means judges whether or not to switch the mode based on the opening operation or the closing operation of the paper cassette 11. For example, when the type specifying mode is set as the mode for finalizing the sheet type, the controller 108 judges whether or not to switch the mode from the type specifying mode to the automatic sensing mode.

Note that a specific method of judgement will be described later.

As illustrated in FIG. 2, the image forming apparatus 100 further includes the transmitter/receiver 106. The transmitter/receiver 106 includes, for example, a network interface card (NIC). Then, a process for communicating with other devices (various external devices) via a communication network such as a local area network (LAN) or the Internet is executed. Thus, the image forming apparatus 100 can accept image data, an image forming job, and the like from another apparatus connected to the communication network. The image forming job may include setting of the type of the sheet S to be used in the image forming process.

Furthermore, the image forming apparatus 100 includes a power supply 107 that is connected to an external power supply. The power supply 107 is connected to the controller 108 and supplies necessary power to each section.

### [Operation of Image Forming Apparatus and Image Forming Method]

Next, an operation of the image forming apparatus 100 will be described, particularly focusing on a process relating to switching of a mode when setting a sheet type.

In the present embodiment, the automatic sensing mode in which the setting of the type of sheet S used for image formation is automatically performed is a default setting. That is, in a state in which no setting is performed by the user, when the sheet S conveyed from the sheet supplier 101 passes through the sensing position of the medium sensing sensor 20, information (determination information) for discriminating the sheet type is automatically acquired. Upon receiving the sensing result (determination information), the controller 108 automatically discriminates (estimates) the type of the sheet S based on the determination information.

Then, in the embodiment, in a case where there is an opening operation or a closing operation of the paper cassette 11 by the user, the controller 108 judges whether or not to switch the mode at the time of setting the sheet type with the opening operation or the closing operation as a trigger.

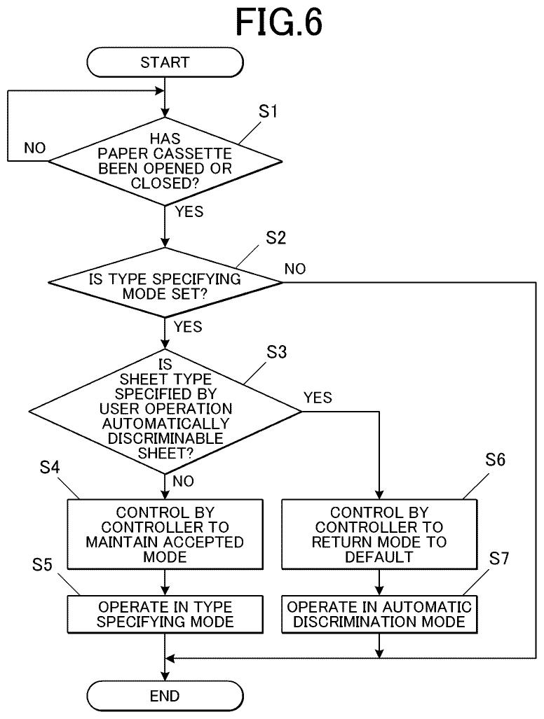

FIG. 6 is a flowchart for explaining the flow of mode switching judgement when setting the sheet type.

As shown in FIG. 6, when the image forming operation is started, the controller 108 judges at any time whether or not the paper cassette 11 is opened and/or closed (step S1). Whether the paper cassette 11 has been opened or closed is judged based on the sensing result outputted from the opening/closing sensing section 111. That is, the controller 108 judges at any time whether or not the sensing result indicating that the opening operation or the closing operation of the paper cassette 11 is sensed is output from the opening/closing sensing section 111. Then, while no sensing result is outputted from the opening/closing sensing section 111 (step S1; NO), the judgement processing is repeated until the sensing result is outputted.

On the other hand, when the sensing result indicating that the opening operation or the closing operation has been performed is output from the opening/closing sensing section 111, it is judged that the paper cassette 11 has been opened or closed (step S1; YES). In this case, the controller 108 further judges whether or not the currently set mode is the type specifying mode for setting the sheet type specified by the user (step S2).

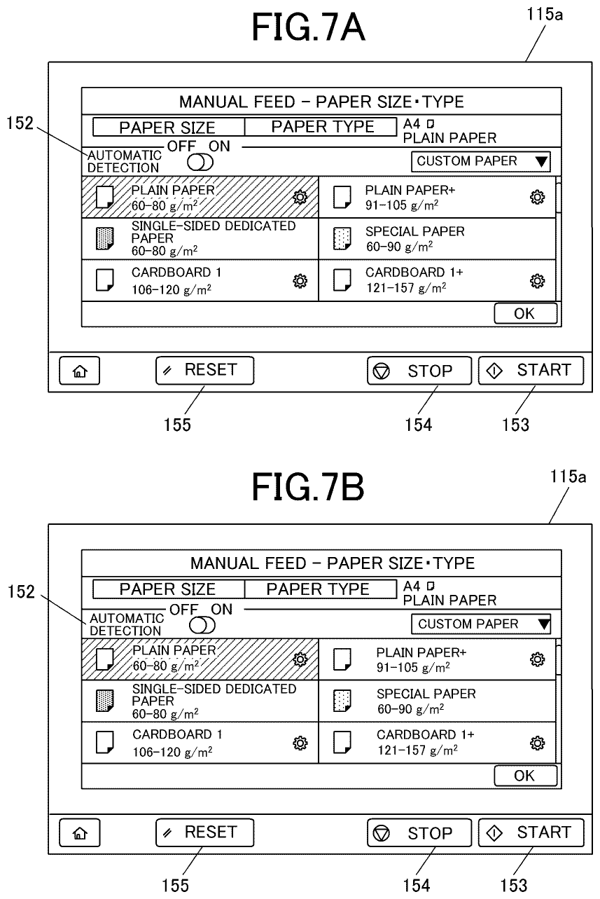

For example, FIG. 7A and FIG. 7B are example setting screens of the operation/display part 105 for setting “sheet size” and “sheet type”. Note that in FIG. 7A and FIG. 7B, “sheet size” and “sheet type” are illustrated.

The setting screen 115a is provided with an ON/OFF selection button 152 for selecting whether to perform automatic detection of the sheet type. When a user selects “OFF” with the ON/OFF selection button 152, a mode (type specifying mode) in which the automatic detection is not performed, and the user manually specifies the sheet type is set. FIG. 7A illustrates a state where the type specifying mode is set. Furthermore, when the user selects “ON” with the ON/OFF selection button 152, a mode for automatically detecting the sheet type (automatic sensing mode) is set. FIG. 7B illustrates a state where the automatic sensing mode is set.

Note that the setting screen 115a is appropriately provided with, for example, a start button 153 for starting printing, a stop button 154 for stopping printing, a reset button 155 for resetting all settings, and the like.

In a case where the mode set at the current time point is not the type specifying mode (step S2; NO), that is, in a case where the current setting is the automatic sensing mode, the controller 108 ends the process without switching the mode.

On the other hand, when the currently set mode is the type specifying mode (step S2; YES), the controller 108 as a switching judging means judges whether or not to switch the mode for setting the sheet type.

In the present embodiment, the mode switching is not always performed in a case where the opening operation or the closing operation of the paper cassette 11 is performed by the user, but the controller 108 judges whether or not to perform the mode switching depending on the type of the sheet S specified in the type specifying mode.

That is, when the opening operation or the closing operation of the paper cassette 11 is sensed in a case where the type specifying mode is set, the controller 108 further judges whether or not the sheet type specified by the user is the sheet S which can be automatically discriminated (step S3).

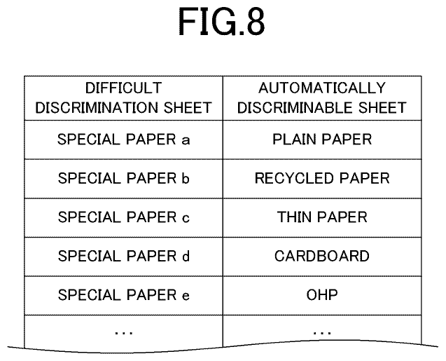

Whether or not the sheet S is of the automatically discriminable type is judged by the controller 108 referring to, for example, a list stored in the storage section 109 or the like. FIG. 8 is a diagram illustrating an example of a list stored in the storage section.

If the sheet S specified by the user is classified as a sheet that is not suitable for automatic discrimination (in the left column in FIG. 8), such as the special paper a, b, c, etc. the controller 108 judges that the sheet type of the sheet S is not suitable for automatic discrimination (step S3; NO).

In this case, the controller 108 performs control to maintain the mode accepted by the input to the operation/display part 105 by the user (step S4). Thus, even after the opening/closing operation of the paper cassette 11, the operation is continued in the type specifying mode in which the user manually specifies the sheet type (step S5).

On the other hand, in a case where the sheet S specified by the user is classified into the automatically discriminable sheet S (column on the right side in FIG. 8) such as plain paper, the controller 108 judges that the sheet type is the automatically discriminable sheet S (step S3; YES).

In this case, the controller 108 controls to return the mode for setting the sheet type to the default mode (step S6). Thus, after the opening and closing operation of the paper cassette 11, the operation is performed in the automatic discrimination mode (step S7).

Note that when switching between the automatic sensing mode and the type specifying mode, the controller 108 preferably causes the display panel 115 of the operation/display part 105 to display a message or the like to notify the user. Furthermore, in a case where a message about a setting change for switching between the automatic sensing mode and the type specifying mode is displayed on the display panel 115, it is preferable to have a plurality of methods for displaying the message.

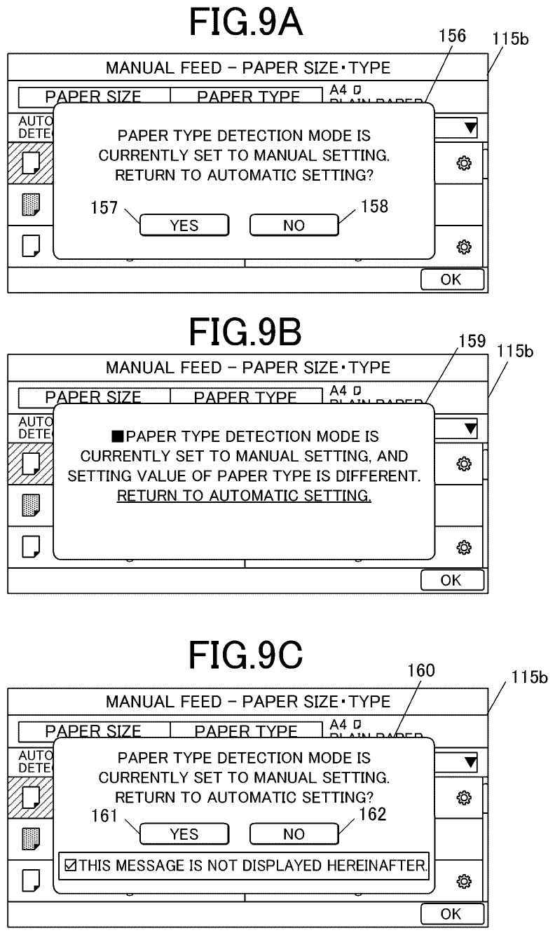

FIG. 9A and FIG. 9C are examples of display screens in a case where a message is displayed on the display panel for a setting change for switching between the automatic sensing mode and the type specifying mode.

For example, in FIG. 9A, the message display 156 displayed on the display screen 115b of the display panel 115 only prompts the user to change the setting to the automatic sensing mode. A message asking the user whether or not to change the type specifying mode to the automatic sensing mode is displayed on the display panel 115. Then, the mode is switched when a YES button 157 is operated, but the mode is not switched when a NO button 158 is operated. In this way, the controller 108 as the switching means may not switch the mode when the image forming section 102 forms the image unless there is an instruction to change the setting by the user.

In FIG. 9B, a message display 159 displayed on the display screen 115b of the display panel 115 notifies the user of a forcible setting change to the automatic sensing mode.

In this case, the controller 108 as the switching unit forcibly switches the mode when the image forming section 102 forms the image to the automatic sensing mode.

Although the change of the setting to the automatic sensing mode has been prompted, in a case where the user denies the change of the setting, for example, as illustrated in FIG. 9C, it may be possible to make a selection of “this message is not displayed hereinafter”. That is, for example, in a case where the user selects the NO button 162 in the message display 160 of the display screen 115b shown in FIG. 9C, the setting change is not displayed again on the display panel 115 unless the check box of the display of “this message is not displayed hereinafter” is removed.

Further, after the setting change to the automatic sensing mode, the user can make a selection so as to return to the original setting (i.e., the type specifying mode) again. In this case, when the original setting is selected again, the setting change may not be displayed again on the display screen 115b of the display panel 115. In addition, in the same manner as illustrated in FIG. 9C, a message “this message is not displayed hereinafter” may be displayed. Then, unless the check box of this message is removed, the setting change may not be displayed again on the display panel 115.

### Effects

As described above, the image forming apparatus 100 according to the present embodiment has an automatic sensing mode in which the type of sheet S is automatically discriminated and a type specifying mode in which the user manually specifies the type of sheet S, and the image forming section 102 performs image formation on the sheet S in one of the automatic sensing mode or the type specifying mode. The controller 108 as a mode setting means judges and sets in which mode image formation is to be performed by the image forming section 102. Furthermore, the controller 108 as a switching judgement means determines whether or not to switch the set mode. Then, in a case where it is judged that the mode is to be switched, the controller 108 as the switching means automatically switches the mode when the image forming section 102 forms the image. Furthermore, in a case where the type specifying mode is set, when it is sensed that the paper cassette 11 storing the sheets S is opened or closed by a user operation, the controller 108 as a switching judging means judges whether or not to switch the mode from the type specifying mode to the automatic sensing mode.

Users who use the user image forming apparatus 100 range from those who are familiar with the sheet type and the like to those who have no knowledge of the sheet type and the like. Therefore, when the type of the sheet S is set, if the mode is uniformly switched between the automatic mode and the manual mode, the image may be formed on the sheet S of an unintended type, and a high-quality finish may not be obtained.

In this regard, in the present embodiment, it is judged whether or not to switch the mode at the time of setting the type of the sheet S when the user's operation of opening and closing the paper cassette 11 is performed. As a result, the setting relating to the judgement of the sheet type can be changed depending on the use situation of the image forming apparatus 100, so that it is possible to meet the demands of various users, and the usability is improved.

Further, the judgement as to whether or not the controller 108 switches the mode is made in accordance with the type of sheet S specified in the type specifying mode when the opening/closing sensing section 111 detects the opening and closing operation of the paper cassette 11.

Accordingly, it is possible to cope with the type of the sheet S while being triggered by the operation of the user. Thus, usability of the image forming apparatus 100 is improved.

Further, when the sheet S specified in the type specifying mode is the paper difficult to be discriminated by the sheet type discriminator, the controller 108 judges to maintain the type specifying mode without switching the mode.

In a case where the sheet S is the paper difficult to be discriminated, when the mode is switched to the automatic sensing mode using the medium sensing sensor 20, there is a possibility that the sheet type is erroneously recognized. If the process conditions are set and the image formation is performed with the different sheet type set, a high-quality result may not be obtained. In this respect, in the case where the paper difficult to be discriminated is specified, by maintaining the type specifying mode, which is the manual setting, it is possible to accurately set the proper sheet type.

Further, in the case where the sheet specified in the type specifying mode is a sheet which can be discriminated by the sheet type discriminator, the controller 108 judges that the type specifying mode is switched to the automatic sensing mode.

Even in a case where a plurality of types of sheets S are used in the automatic sensing mode, it is not necessary for the user to set the sheet type each time, which is simple. For this reason, in a case where the sheet type can be correctly discriminated based on the sensing result of the medium sensing sensor 20, it is possible to reduce the burden on the user by setting the automatic sensing mode.

The image forming apparatus 100 according to the embodiment further includes an operation/display part 105 that includes a display panel 115 and is used to notify the user of various apparatus states, messages, and the like. In a case where the automatic sensing mode and the type specifying mode are switched, a display is provided on the display panel 115.

Thus, the user can recognize that the mode is switched. Therefore, it is possible to prevent image formation from being performed on a wrong sheet S without noticing the switching of the mode.

In a case where a message about a setting change for switching between the automatic sensing mode and the type specifying mode is displayed on the display panel 115, the present embodiment includes a plurality of message display methods.

For example, the message display displayed on the display panel 115 may be nothing more than prompting to change the setting to the automatic sensing mode. In this case, the controller 108 may not switch the mode when the image forming section 102 forms the image unless there is an instruction to change the setting by the user.

In this case, it is possible to notify the user who does not recognize the presence of the automatic sensing mode that the setting change to the automatic sensing mode is possible, and it is possible to leave the judgement of whether to switch to the automatic sensing mode to the user.

Furthermore, the message display to be displayed on the display panel 115 may be for providing notification of a forcible setting change to the automatic sensing mode. In this case, the controller 108 may forcibly switch the mode when the image forming section 102 forms the image to the automatic sensing mode.

In this case, it is possible to inform the user that the mode will be changed, and it is possible to prevent a situation in which the mode is suddenly switched, and image formation is performed on the unintended sheet S. In addition, it is possible to save time and effort of the user who responds to an inquiry as to whether to perform switching.

Furthermore, in a case where the original setting is selected again after the setting change to the automatic sensing mode, the setting change may not be displayed again on the display panel 115.

Thus, it is possible to avoid troublesomeness that confirmation of the setting change is required one by one.

Furthermore, in the embodiment, the sheet type discriminator includes the measuring section for irradiating the sheet S with light and measuring physical properties of the sheet S by the transmittance and reflectance of the irradiated light. The measuring means is, for example, the medium sensing sensor 20. The controller 108 discriminates the type of the sheet S on the basis of the measurement result obtained by such a measurement unit, so that it is possible to easily and accurately discriminate the sheet type and appropriately set the process conditions and the like.

### Second Embodiment

Next, a second embodiment of the image forming apparatus, the image forming method, and the storage medium according to the present invention will be described. Note that in the present embodiment, processing related to switching of modes when setting a sheet type is different from that in the first embodiment. The apparatus configuration is the same as that described in the first embodiment, and thus the description thereof will be omitted. In the following, differences from the first embodiment in particular will be described.

In the present embodiment, in the case where at least one of the opening operation and/or the closing operation of the paper cassette 11 is detected by the opening/closing sensing section 111, the controller 108 functioning as a switching judging means judges whether or not the mode is to be switched depending on the operation state of the image forming job.

When at least one of the opening operation and/or the closing operation of the paper cassette 11 is sensed by the opening/closing sensing section 111 in the middle of a series of image forming jobs, the controller 108 as the switching judgement means judges to maintain the type specifying mode without switching the mode. That is, when there is a job currently being executed, even if the paper cassette 11 is opened or closed due to the absence of the sheet S in the paper cassette 11 in the middle of the job or the like, the controller 108 does not switch the mode.

On the other hand, in a case where at least one of the opening operation and/or the closing operation of the paper cassette 11 is sensed by the opening/closing sensing section 111 in a state where there is no image forming job being on standby or having been accepted, the controller 108 as the switching judging means judges to switch the mode.

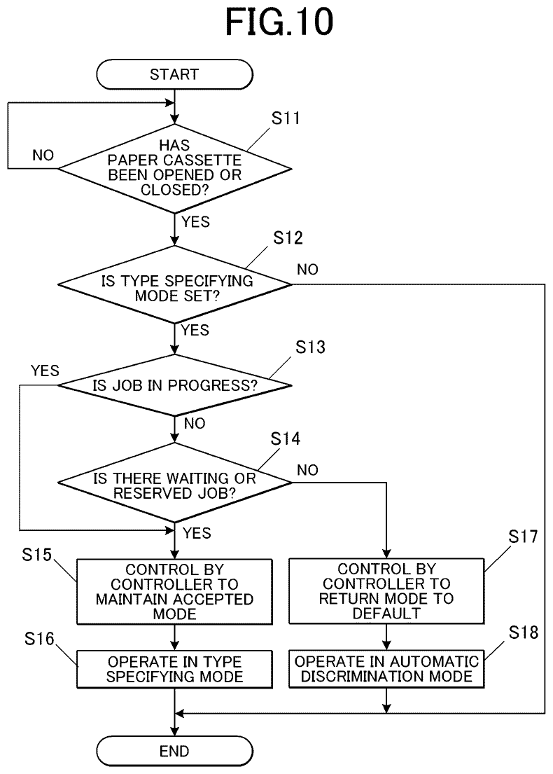

FIG. 10 is a flowchart for explaining the flow of mode switching judgement when setting the sheet type in the present embodiment.

Note that step S11 and step S12 illustrated in FIG. 10 are identical to step S1 and step S2 illustrated in FIG. 6. Step S15 to step S18 illustrated in FIG. 10 are identical to step S4 to step S7 illustrated in FIG. 6. Therefore, step S13 and step S14 in particular will be described here.

Also in the present embodiment, similarly to the first embodiment, in a case where the currently set mode is the type specifying mode for setting the sheet type specified by the user (step S12; YES), the controller 108 as the switching judgement means judges whether or not to switch the mode for setting the sheet type.

In the present embodiment, switching of the mode is not always performed in a case where there is an opening operation or a closing operation of the paper cassette 11 by the user, but as described above, the controller 108 judges whether or not to switch the mode in accordance with the operating state of the image forming job.

That is, first, the controller 108 judges whether or not there is an image forming job currently being executed (step S13). If the job currently being executed is in progress (step S13; YES), the controller 108 controls each component so as to maintain the accepted mode (steps S15 and S16).

On the other hand, when there is no job currently being executed (step S13; NO), the controller 108 further judges whether or not there is a waiting or reserved job (step S14). If there is a standby or reserved job (step S14; YES), the controller 108 controls each section to maintain the accepted mode (steps S15 and S16).

On the other hand, when there is no currently waiting or reserved job (step S14; NO), the controller 108 controls each component so as to return the mode for setting the sheet type to the default mode (steps S17 and S18).

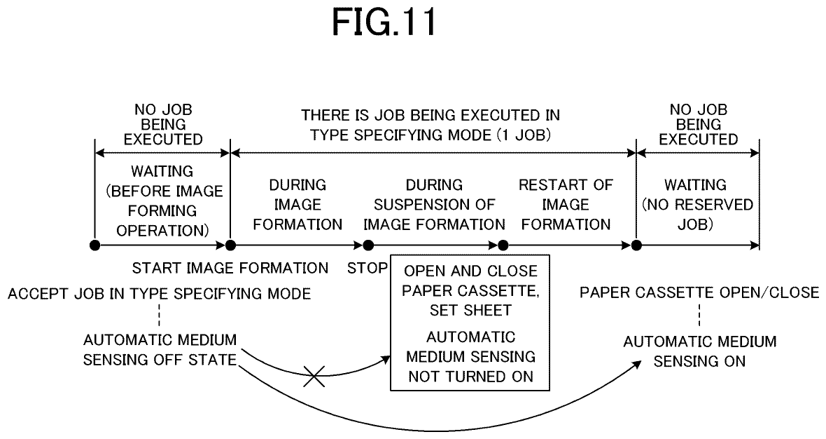

FIG. 11 is an explanatory diagram schematically illustrating processing in a case where there is one image forming job being executed in the type specifying mode, and there is no reserved job (image forming job being on standby and having been accepted) that has already been input from the operation/display part 105 or the like and accepted by the controller 108. In FIG. 11, the time series is set from left to right.

As shown in FIG. 11, in this case, when the sheets S used during the image formation run out, the image forming operation is stopped. The fact that the sheets S have run out is notified to the user by display on the display panel 115 of the operation/display part 105, various beep sounds, or the like.

When the user receives this notification, opens the paper cassette 11, sets (refills) sheets S, and closes the paper cassettes 11 again, this opening operation or closing operation is sensed by the opening/closing sensing section 111. Next, a sensing result of the opening/closing sensing section 111 is output to the controller 108. However, as shown in step S13; YES in FIG. 10, when the job being executed is in progress, even if the opening operation or the closing operation of the paper cassette 11 is sensed, the mode is not switched. In this case, the controller 108 performs control so as to maintain the type specifying mode.

In a case where the image forming job for which the type specifying mode is set is being executed, it is assumed that the same user executes the rest of the image forming job even after the sheet S is refilled. Therefore, if the mode is switched halfway, the user feels inconvenience. Further, an unexpected error may occur depending on the specified type of the sheet S. Therefore, it is preferable to maintain the set mode.

On the other hand, when the image forming job for which the type specifying mode is set is finished and there is no job being executed or no reserved job, the controller 108 controls each unit to return the mode for setting the sheet type from the type specifying mode to the default automatic sensing mode at the time when the opening/closing operation of the paper cassette 11 is sensed.

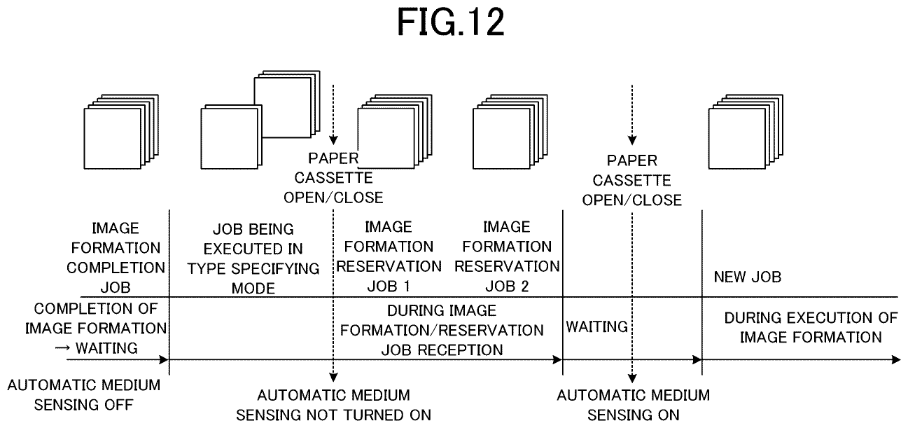

FIG. 12 illustrates a case where the paper cassette 11 is opened and/or closed at the time point when the image forming job being executed in the type specifying mode is completed. However, in the example illustrated in FIG. 12, the image forming jobs 1 and 2 which have already been reserved are accepted by the controller 108. FIG. 12 is an explanatory diagram schematically illustrating processing in a case where a plurality of image forming jobs are set in this manner. Also in FIG. 12, the time series is set from left to right.

As illustrated in FIG. 12, in a case where there are already reserved image jobs, even if some of the accepted jobs is completed, the reserved jobs are considered as one (a series of) job as a whole. Then, even when the paper cassette 11 is opened and/or closed in the middle of a series of jobs, the controller 108 performs control so that the mode is not switched and the type specifying mode is maintained.

In this way, it is assumed that the same user performs similar processing in a case where there are a plurality of reserved jobs. Therefore, if the mode is switched in the middle, the user feels inconvenience. In addition, an unexpected error may occur depending on the type of the specified sheet S, and it is preferable to maintain the set mode.

Note that even in a case where there are a plurality of jobs, in a case of a new job separated from a series of jobs, the controller 108 switches the mode when there is an opening and/or closing operation of the paper cassette 11. That is, in the case where the opening and/or closing operation of the paper cassette 11 is sensed before the start of the new job on the right side of FIG. 12, the controller 108 controls the respective units so as to return the mode for setting the sheet type from the type specifying mode to the default automatic sensing mode at that time.

In what case the job is judged to be the new job separated from the series of jobs is appropriately set. For example, a predetermined amount of time may have elapsed from the end of a series of jobs to the acceptance of the next job. Furthermore, a job that has been accepted with a different user ID or the like from a previous job, a job that has been accepted from a different terminal device, or the like is also considered to be a new job.

In these cases, it is considered that the necessity of continuing the specifying of the type of the sheet S set by the user is low. Therefore, it is preferable that the job is processed as a new job in the default automatic sensing mode.

As described above, in the present embodiment, in the case where at least one of the opening operation and/or the closing operation of the paper cassette 11 is detected by the opening/closing sensing section 111, the controller 108 as the switching judging means judges whether or not the mode is to be switched in accordance with the operation state of the image forming job at that time.

Accordingly, it is possible to prevent the mode from being unintentionally switched in the middle of the image forming job while using the opening and/or closing of the paper cassette 11 as a trigger of the judgement of the mode switching.

In addition, in a case where at least one of the opening operation and/or the closing operation of the paper cassette 11 is detected by the opening/closing sensing section 111 in the middle of a series of image forming jobs, the controller 108 judges to maintain the type specifying mode without switching the mode.

As a result, even after the refill of the sheet S, when the same user intends to continue the image forming job, it is possible to prevent the setting from being changed against the will.

Furthermore, in a case where at least one of the opening operation and/or the closing operation of the paper cassette 11 is sensed by the opening/closing sensing section 111 in a state where there is no image forming job in standby or accepted, the controller 108 switches the mode from the type specifying mode to the automatic sensing mode.

Thus, in a case where the paper cassette 11 is opened and/or closed before a new job is started, it is possible to perform processing in the default automatic sensing mode which is easy to use even for the user having little knowledge about the sheet type.

### Modification Example

Note that the present invention is not limited to the above-described embodiment, and it is needless to say that appropriate changes can be made without departing from the spirit of the present invention.

For example, in the first embodiment described above, as the processing relating to the switching of the mode when the sheet type is set, the case where it is judged whether or not to switch from the type specifying mode to the automatic discrimination mode according to the type of the sheet S specified by the user has been described. Furthermore, in the second embodiment, the case where whether to switch from the type specifying mode to the automatic discrimination mode is judged according to the status of the image forming job has been described.

However, the contents described in the first embodiment and the contents described in the second embodiment do not contradict each other. For example, it is also possible to judge whether or not to switch the mode when setting the sheet type by combining both.

Furthermore, the various types of settings by the user are not limited to those input from the operation/display part 105 of the image forming apparatus 100.

For example, the setting may be input and set from various terminal devices or the like connected to the image forming apparatus 100 via a communication network.

Furthermore, in the present embodiment, for example, in FIG. 7A and FIG. 7B and the like, the case where the user sets enablement/disablement of the automatic sensing mode and the type specifying mode has been described. However, the automatic sensing mode and the type specifying mode may be enabled/disabled by an administrator who manages the image forming apparatus 100.

Furthermore, the image forming apparatus may have an administrator mode in which only an administrator can set whether the automatic sensing mode and the type specifying mode are enabled or disabled and a user mode in which the user can set whether the automatic sensing mode and the type specifying mode are enabled or disabled.

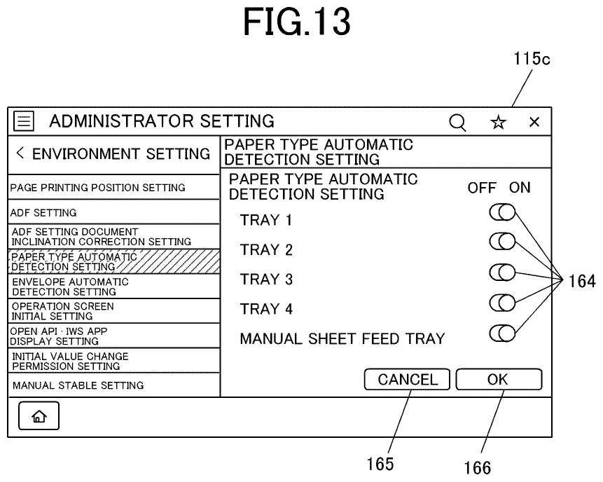

FIG. 13 is an example of a screen illustrating an example of an administrator setting screen on which the administrator performs various kinds of setting.

For example, on the administrator setting screen 115c illustrated in FIG. 13, automatic sheet type sensing (“automatic paper type detection” in FIG. 13) can be set for each paper cassette 11 (“tray” in FIG. 13). That is, the administrator setting screen 115c is provided with a switch 164 for switching ON/OFF of the sheet type automatic sensing for each paper cassette 11 (“tray” in FIG. 13). When the switch 164 is moved to the left side, the sheet type automatic sensing is turned off. When the switch 164 is moved to the right side, the sheet type automatic sensing is turned on. In the illustrated example, the sheet type automatic sensing is set to ON for all the paper cassettes 11.

The administrator setting screen 115c is also provided with a cancel button 165 to cancel the setting and an OK button 166 to approve the setting, so that the settings in the administrator setting screen 115c can be collectively cancelled or collectively approved.

On the administrator setting screen 115c, in addition to the setting of the sheet type automatic sensing, for example, various settings such as an initial setting of the operation screen can be performed.

Since the administrator can perform various settings, it is possible to perform various settings in a unified manner according to the environment in which the image forming apparatus is used.

Besides, the configuration and operation of the image forming apparatus 100 can be appropriately modified without departing from the spirit and scope of the present invention.

Although embodiments of the present invention have been described and shown in detail, the disclosed embodiments are made for purposes of illustration and example only and not limitation. The scope of the present invention should be interpreted by terms of the appended claims.

What is claimed is:

1. An image forming apparatus comprising:
a hardware processor;
a supplier that supplies a sheet;
an image former; and
a sensor that senses at least one of an operation of opening and/or closing a paper cassette containing the sheet by a user operation,
wherein,
the hardware processor discriminates a sheet type supplied by the supplier,
the hardware processor accepts specifying of the sheet type by a user,
an image is formed in any mode between an automatic sensing mode in which the image former forms the image on the supplied sheet by the sheet type discriminated by the hardware processor, and a type specifying mode in which the image former forms the image on the supplied sheet based on the sheet type accepted by the hardware processor, the hardware processor judges and sets in which mode the image is formed by the image former,
the hardware processor judges whether to switch the set mode,
in a case in which it is judged that the mode is switched, the hardware processor automatically switches the mode when the image former forms the image, and
in a case in which the type specifying mode is set, the hardware processor judges, based on sensing of at least one of the operation of opening and/or the operation of closing by the sensor, whether or not to switch the mode from the type specifying mode to the automatic sensing mode.

2. The image forming apparatus according to claim 1, further comprising a display that includes a display panel, and that notifies the user of various apparatus states and messages,
wherein it is displayed on the display panel in a case that switching is performed between the automatic sensing mode and the type specifying mode.

3. The image forming apparatus according to claim 1, wherein the hardware processor judges whether or not to switch the mode in accordance with the sheet type specified in the type specifying mode in a case in which the sensor senses at least one of the operation of opening the paper cassette and/or the operation of closing the paper cassette.

4. The image forming apparatus according to claim 3, wherein in a case in which the sheet specified in the type specifying mode is the sheet that is difficult to be discriminated by the hardware processor, the hardware processor judges to maintain the type specifying mode without switching the mode.

5. The image forming apparatus according to claim 3, wherein in a case in which the sheet specified in the type specifying mode is discriminable by the hardware processor, the hardware processor judges to switch the type specifying mode to the automatic sensing mode.

6. The image forming apparatus according to claim 1, wherein a judgement as to whether or not the hardware processor switches the mode is performed in accordance with an operation state of an image forming job in a case in which at least one of the operation of opening the paper cassette and/or the operation of closing the paper cassette is sensed by the sensor.

7. The image forming apparatus according to claim 6, wherein in a case in which at least one of the operation of opening the paper cassette and/or the operation of closing the paper cassette is sensed by the sensor in the middle of a series of image forming jobs, the hardware processor judges to maintain the type specifying mode without switching the mode.

8. The image forming apparatus according to claim 6, wherein in a case in which at least one of the operation of opening the paper cassette and/or the operation of closing the paper cassette is sensed by the sensor in a state in which there is no image forming job that is on standby or has been accepted, the hardware processor judges to maintain the type specifying mode without switching the mode.

9. The image forming apparatus according to claim 1, wherein the image forming apparatus includes an administrator mode in which only an administrator can set validity/invalidity of the automatic sensing mode and the type specifying mode, and a user mode in which the user can set the validity/invalidity.

10. The image forming apparatus according to claim 2, wherein in a case in which a message is displayed on the display panel for a setting change to switch between the automatic sensing mode and the type specifying mode, the image forming apparatus includes a plurality of message display methods.

11. The image forming apparatus according to claim 10, wherein,
the message display displayed on the display panel merely prompts a change of setting to the automatic sensing mode, and
the hardware processor does not switch the mode in which the image former forms the image unless an instruction to change the setting is provided by the user.

12. The image forming apparatus according to claim 10, wherein,
the message display displayed on the display panel notifies a forcible setting change to the automatic sensing mode, and
the hardware processor forcibly switches the mode when the image former forms the image to the automatic sensing mode.

13. The image forming apparatus according to claim 10, wherein,
after the setting is changed to the automatic sensing mode, an original setting can be selected again, and
a display to change the setting is not displayed on the display panel again in a case in which it is once selected to set to the original setting again.

14. The image forming apparatus according to claim 1, wherein the hardware processor includes a measurer that irradiates the sheet with light and measures physical properties of the sheet by transmittance and reflectance of the light that is irradiated and discriminates the sheet type based on a measurement result by the measurer.

15. An image forming method comprising:
discriminating a sheet type of a sheet supplied by a supplier;
accepting specification of the sheet type by a user;
forming an image in any mode between an automatic sensing mode in which an image is formed on the supplied sheet in accordance with the discriminated sheet type, and a type specifying mode in which the image is formed on the supplied sheet in accordance with the accepted sheet type,
judging and setting in which mode the image is formed in the image forming;
judging whether to switch the mode set in the mode setting;
in a case in which it is judged in the determining of switching that the mode is to be switched, automatically switching the mode when the image is formed in the image forming; and
sensing at least one of an operation of opening and/or an operation of closing a paper cassette containing the sheet by a user operation,
wherein in a case in which the type specifying mode is set in the mode setting, it is judged in the judging of switching, whether to switch the mode from the type specifying mode to the automatic sensing mode, based on sensing of at least one of the operation of opening and/or the operation of closing.

16. A non-transitory computer readable storage medium storing a program causing a computer to perform:
discriminating a sheet type of a sheet supplied by a supplier;
accepting specification of the sheet type by a user;
forming an image in any mode between an automatic sensing mode in which an image is formed on the supplied sheet in accordance with the discriminated sheet type, and a type specifying mode in which the image is formed on the supplied sheet in accordance with the accepted sheet type,
judging and setting in which mode the image is formed in the image forming;
judging whether to switch the mode set in the mode setting;
in a case in which it is judged in the determining of switching that the mode is to be switched, automatically switching the mode when the image is formed in the image forming; and
sensing at least one of an operation of opening and/or an operation of closing a paper cassette containing the sheet by a user operation,
wherein in a case in which the type specifying mode is set in the mode setting, it is judged in the judging of switching, whether to switch the mode from the type specifying mode to the automatic sensing mode, based on sensing of at least one of the operation of opening and/or the operation of closing.
